(19) United States
(12) Patent Application Publication
(10) Pub. No.: US 2007/0148627 A1
(43) Pub. Date: Jun. 28, 2007

(54) Merchandising method and system

(76) Inventors: Katherine Assimon Dusckas, Camillus, NY (US); Bruce Joseph Bader, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/315,026

(22) Filed: Dec. 22, 2005

(51) Int. Cl. G09B 25/00

(52) U.S. Cl. 434/365

(57) ABSTRACT

Activity themes may be selected, each activity theme corresponding to an activity performed by a child during a day. An activity theme area may be established, including a display area and a learning station in close proximity to the display area. Goods relating to the activity theme may be displayed in the display area while instructional materials relating to the activity theme may be provided at the learning station.

### FIELD OF THE DISCLOSURE

The present disclosure generally relates to a merchandising method and system, and in particular to a merchandising method and system for children's goods.

### BACKGROUND OF THE INVENTION

While shopping can be a pleasant experience, it is not always perceived as such. Shopping can take attention away from other things that need to get done during the day, or which the shopper would like to get done during the day. For example, for a caregiver with small children, the time spent shopping represents time that cannot be spent doing other activities, such as reading to the children or otherwise interacting with or instructing the children. Shopping can also lead to real tension between the caregiver/shopper and the child, in that the shopping experience does not engage the child, and the child may thus behave inappropriately in an attempt to obtain attention from the caregiver while the caregiver is attempting to complete the shopping trip. At the same time, the shopper may be dealing with the frustration of being unable to find the goods he or she is looking for because of an unfamiliar organizational system. As a consequence, a shopper may come to look on shopping as a necessary evil, or may be in some way resentful of the time spent.

Accordingly, it would be desirable to provide a merchandising system that offers a pleasant shopping experience for the shopper or customer.

### SUMMARY OF THE INVENTION

In one aspect, a merchandising method includes selecting a plurality of activity themes, each activity theme corresponding to an activity performed by a child during a day. The method also includes separating goods according to the plurality of activity themes, the goods for one of the plurality of activity themes to be displayed in a display area for the one of the plurality of activity themes, and providing instructional materials according to the plurality of activity themes to assist a caregiver in instructing a child regarding the respective activity theme, the instructional materials for one of the plurality of activity themes to be disposed at a learning station in close proximity to the display area for the one of the plurality of activity themes.

In another aspect, a merchandising method includes establishing an activity theme area in a sales forum for each of a plurality of activity themes, each activity theme corresponding to an activity performed by a child during a day, and each activity theme area including a display area and a learning station in close proximity to the display area. The method also includes displaying goods corresponding to each activity theme in the respective display area, and providing instructional materials related to each activity theme in the respective learning station to assist a caregiver in instructing a child regarding the respective activity theme.

In a further aspect, a merchandising system includes a plurality of activity theme areas in a sales forum for each of a plurality of activity themes, each activity theme corresponding to an activity performed by a child during a day, and each activity theme area including a display area and a learning station in close proximity to the display area. The display area includes a display for goods corresponding to the activity theme, and the learning station includes instructional materials related to the activity theme to assist a caregiver in instructing a child regarding the respective activity theme.

Additional aspects of the disclosure are defined by the claims of this patent.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. None of the drawings are necessarily to scale.

FIG. 1 is a flowchart illustrating a merchandising method according to a first aspect of the disclosure;

FIG. 2 is a flowchart illustrating a merchandising method according to a second aspect of the disclosure;

FIG. 3 is a partial schematic view of an embodiment of a merchandising system according to the disclosure;

FIG. 4 is an elevational view of the embodiment of FIG. 3;

FIG. 5 is a partial schematic view of another embodiment of a merchandising system according to the disclosure;

FIG. 6 is a plan view of the embodiment of FIG. 5; and

FIG. 7 is a schematic view of still another embodiment of a merchandising system according to the disclosure.

### DETAILED DESCRIPTION OF THE INVENTION

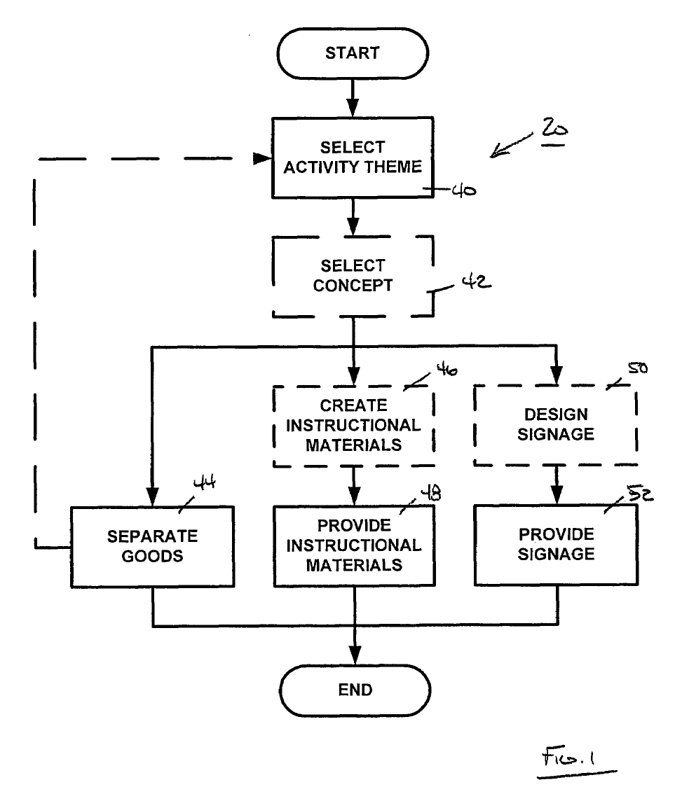

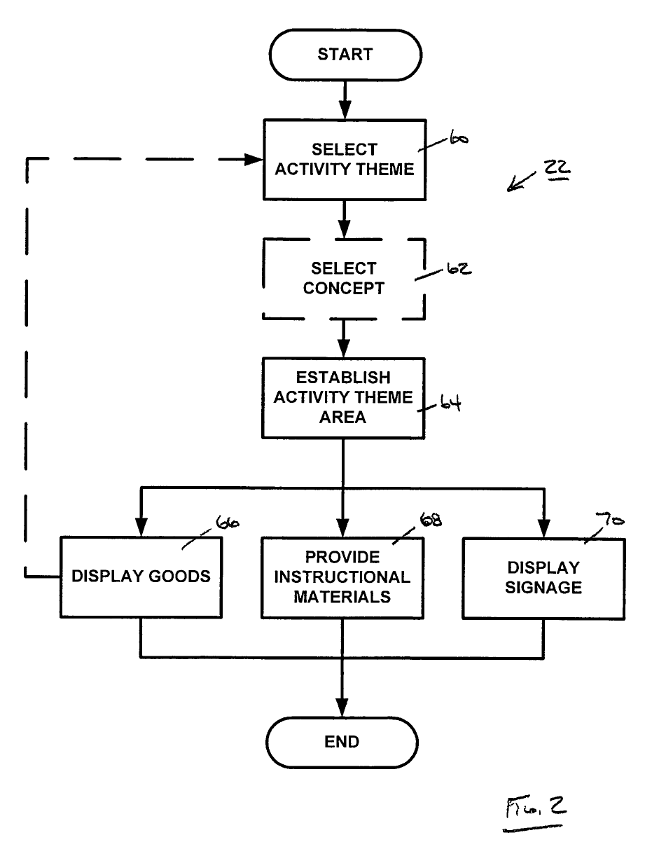

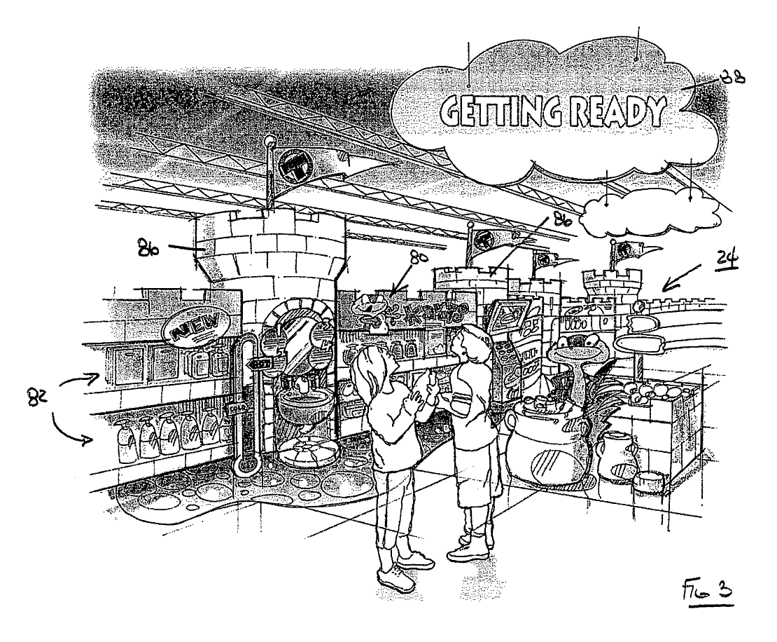

FIGS. 1 and 2 illustrate merchandising methods 20, 22 according to the present disclosure. The methods 20, 22 may be used in conjunction with each other, and according to such an embodiment, for example, the method 20 may be performed by a manufacturer of children's goods, while the method 22 may be performed by the operator of a sales forum, such as a retail store or establishment. On the other hand, FIGS. 3-7 illustrate embodiments of a merchandising system 24, 26, 28 according to the present disclosure, which embodiments are useful in explaining the methods 20, 22 illustrated in FIGS. 1 and 2.

Turning first to the method 20 illustrated in FIG. 1, the method 20 may begin at a block 40, wherein selection of activity themes may be performed.

In this regard, it will be recognized that while what one child does during a day may vary greatly from what another child may do in the same period, certain aspects of the daily routine may be common to most children within a certain age group, such as the age group of 3-7 years old. For example, most children in this age group wake up, get dressed, eat meals, get ready for bed, and sleep. Many children in this age group spend at least part of their time each day playing or having stories read to them. These children may have a morning and/or an afternoon snack. Additionally, children ages 3-7 are typically involved in some form of organized activity outside the house and away from a primary caregiver, such as a play group, an enrichment class or school. In this regard, the term “caregiver” refers to a person other than the child, such as, a parent, babysitter, family member, day care worker, or other person who is able to provide assistance to the child to complete a personal task. Any, some or all of these aspects of the daily routine may be selected as an activity theme by the decision maker.

For example, according to one embodiment, the decision maker may select the following activity themes: Getting Dressed, Schooltime, Healthy Snacking, Playtime, Storytime, Bedtime, and Getting Ready. According to such an embodiment, the Getting Dressed activity theme may refer to that the time of day in which the child puts on or the caregiver puts on the child clothing suitable for other than the bedroom. The Schooltime activity theme may refer to the time of day in which the child participates in organized activity outside of the house, whether that is in the form of the activities normally associated with organized education, or some other organized activity outside of the house. The Healthy Snacking activity theme may refer to the time of day, in between major meals, such as breakfast, lunch, and dinner, during which the child eats food. The Playtime activity theme may refer to the time of day in which the child interacts with toys, crafting materials, musical instruments, and the like. The Storytime activity theme may refer to the time of day in which the child reads or a caregiver reads to the child a story, or during which a story is communicated to the child, through the use of puppets or animation, for example. The Bedtime activity theme may refer to the time of day in which the child prepares or is assisted by a caregiver in preparing to go to sleep, and goes to sleep. The Getting Ready activity theme may refer to that time of day in which the child is prepared for an activity that is not represented in one of the other themes.

It will be recognized that the selection of the terminology to be used to express a particular activity theme and the aspects of the daily routine to be included with a given activity theme is not confined to the preceding embodiment. For example, certain of the activity themes listed above were referenced according to a certain “Time”: e.g., Schooltime, Playtime, Bedtime, and Storytime. Other theme terminology was not so confined: e.g., Getting Ready, Healthy Snacking, and Getting Dressed. According to alternative embodiments, Snacktime could be used in place of Healthy Snacking, or Going to School could be used in place of Schooltime. Furthermore, additional themes may be included, such as Going Out, which may be used to refer to that time of day spent by the child in getting from home to an activity represented by another activity theme (e.g., Schooltime) or an activity that is not represented (e.g., going with the caregiver to the store).

Nor is the decision maker necessarily making these selections unguided by decisions that are dependent upon the selection of the activity themes. That is, the activity themes are used as an organizational tool throughout the remainder of the method 20 still to follow. For example, the activity themes may be used to separate a wide variety of goods or products into discrete groups for the customer (e.g., the caregiver and the child). A decision-maker may select certain activity themes over others, for example, where the activity themes selected permit all of the goods to be sorted into one theme or another, and other possible activity themes might have no or only a limited number of goods associated therewith. As a consequence, activity themes that are otherwise acceptable from the point of view that the activity themes are valid observations of the daily routine of most children may be unacceptable because of the downstream impact the selections may have. Thus, there may be, as illustrated by the dashed lines extending from blocks further along the method 20, feedback occurring when the decision-maker is making its selection of the activity themes.

At block 42, the decision-maker may optionally select a concept for use with the merchandising method 20. That is, the decision-maker, having selected a plurality of activity themes into which to divide the daily routine of a child, may choose one or more concepts to be used in conjunction with the presentation of these activity themes. A concept may refer to a set of design elements, which may be visual, audible, etc., that are commonly associated with a group of people, a particular location, a particular occupation, etc. For example, the concept may be a Castle, for which towers, crenellated walls, pennants, dragons, knights, kings and princesses may be design elements. Alternatively, the concept may be Pirates, for which sailing ships, islands, buried treasure and palm trees may be design elements. Still other examples of concepts may include Backyard, Hollywood, Circus, Safari, and Marketplace.

With the concept selected at block 42, the design elements associated with the concept may be used in other steps of the method 20, as explained in greater detail below. However, it will also be recognized that the subsequent steps of the method 20 do not rely on a concept having been selected. That is the selection of goods, for example, may not be influenced at all by the selection of a concept. On the other hand, if a concept has been selected, the design elements associated with the concept may be used in the design of signage or the creation of instructional materials, as explained below.

After the block 42, the method 20 may branch, as illustrated, to indicate that several activities may now be undertaken by the party performing the method 20 contemporaneously with each other. It is not necessary, however, that the method 20 branch, as illustrated. Instead, the activities represented by blocks 44, 46, 48, 50, 52 may be performed sequentially, or certain blocks may be performed at the same time, while other blocks are performed sequentially.

Referring first to the leftmost branch, the method 20 may continue with the separation of goods at block 44 according to the plurality of activity themes selected at block 40. The same party that made the selection of the activity themes at block 40 may separate the goods at block 44. For example, the method 20 may be performed by a manufacturer of children's goods or products, in which case the manufacturer may select the activity themes at block 40 and then separate its goods according to the selected themes at block 44.

For example, using the themes selected above, goods associated with the Schooltime activity theme may include backpacks, paper, notebooks, writing instruments, rulers, art supplies, lunchboxes, and other supplies. Goods associated with the Healthy Snacking activity theme may include juices, sports drinks, bottled water, fruit, and fruit snacks. Goods associated with the Playtime activity theme may include electronics, sports equipment, dolls, action figures, puzzles, and other toys. Goods associated with Bedtime activity theme may include pillows, sheets, comforters, blankets, pajamas, slippers, nighttime training pants and alarm clocks. Goods associated with Getting Dressed activity theme may include training pants, underwear, socks, play clothes, school clothes, dress clothes, shoes, and seasonal clothes. Goods associated with the Storytime activity theme may include books, read-along book sets, videos, and puppets. Goods associated with the Getting Ready activity theme may include soap, toothpaste, toothbrushes, sun lotion, shampoo, and cosmetics. It will be recognized that these lists are exemplary, and not exhaustive.

Given the variety of products that may be associated with each activity theme, it may not be possible for one manufacturer to provide all of the goods associated with a given activity theme. In certain circumstances, the manufacturer that selects the activity themes and the concept (optionally) and separates the goods according to the activity themes is able to produce or to have produced for it all of the goods identified with each activity theme. It will be recognized that the method 20 is not limited to only such situations, and the method could be performed, for example, by a manufacturer that only produces certain of the products associated with each activity theme, but which carries out the merchandising method 20 because of the advantages of such a method, as are explained in greater detail below.

At the same time as block 44 is being performed, or at some time before or after it is performed, instructional materials are created and provided at blocks 46, 48 according to the activity themes selected, the instructional materials capable of assisting a caregiver in instructing a child regarding one of the activity themes selected. For example, continuing the embodiment discussed above wherein a manufacturer of children's goods is performing the method 20, the manufacturer at block 46 may create instructional materials using an internal creative design function of the manufacturer, or may hire a third party to create such instructional materials for the manufacturer. Whatever the source, the manufacturer at block 48 then provides the instructional materials to a party who will provide the instructional materials to the caregiver or child, which party may be an operator of a sales forum, such as a retail establishment.

The instructional materials may be used by a caregiver to instruct a child in certain topics relating to the activities of the daily routine to which the activity themes relate. These instructional materials may be similarly structured or may useful for instructing similar lessons for each of the activity themes. For example, the instructional materials may be created for a caregiver to use to instruct a child about safety, manners or hygiene relating to the activity theme. The instruction materials for each activity theme may address all three topics. Alternatively, the instructional materials for each activity theme may be structured to highlight different topics.

For example, in relation to the Getting Ready activity theme, instructional materials may be provided relating to safety, manners, and hygiene. In regard to safety, the materials may emphasize the importance of checking the temperature of the water before hand washing. In regarding to manners, the materials may emphasize that it is appropriate to only throw toilet paper and flushable wipes down the toilet. In regard to hygiene, the materials may emphasize that teeth need to be brushed for two minutes, or that hands need to be washed for twenty seconds.

The instructional materials may be, to varying degrees, interactive. Certain instructional materials may be interactive to the extent that they may be used by a caregiver with a child to stimulate a dialog between the caregiver and the child regarding the activity theme. For example, a graphic showing an androgynous character, like a frog, wearing a night cap and brushing its teeth may be used by the caregiver to begin a dialog regarding the need for the child to brush his or her teeth before bed. Other instructional materials, such as checklists that the caregiver or child may take home with them, may provide the caregiver with an opportunity to have a dialog with the child regarding the importance of some aspect of the activity theme and then reinforce the dialog with positive reinforcement by tracking the child's performance on the check list. Still other instructional materials may comprise more than simple illustrated or written materials, and may include elements that vary in response to actions carried out by the caregiver and/or child. For example, the instructional material may include a display unit with a touch screen, the display unit capable of displaying animations relating to proper hygiene or manners relating to the activity theme and questions relating to the same, the animations varying in response to answers signaled by the caregiver or child via the touch screen. Similarly, the instruction material may include a webpage reachable through the use of browser software, the caregiver and/or child signaling responses and the responses causing the content of the webpage to change or cause other webpages to be displayed.

Other activities may also be carried out, as indicated in FIG. 1. For example, signage that represents the activity theme may be designed and provided at blocks 50, 52. The signage may include letters, but in consideration of the fact that the merchandising method 20 may target an age group, such as the 3-7 year old age group, which may be pre-literate, the signage may also include pre-literate symbols, or a combination of letters and pre-literate symbols. For example, the signage for the Bedtime activity theme may include the word “Bedtime” as a visual cue for a caregiver, and a picture of a bed as a visual cue for the child. As another example, the Health Snacking activity theme signage may include images representative of apples, oranges, and bananas, as well as the words “Healthy Snacking.” As was the case with the instructional materials, the signage may be designed by the manufacturer, or by a party that the manufacturer hires or contracts with for this purpose.

Having thus described the method 20 illustrated in FIG. 1, reference is now made to the method 22 illustrated in FIG. 2. To the extent that a goods or products manufacturer may perform or carry out the merchandising method of FIG. 1, an operator of a sales forum may perform or carry out the merchandising method according to FIG. 2. That is, having performed the method 20 illustrated in FIG. 1, the manufacturer may turn the activity themes, lists of associated goods, instructional materials, and signage over to the sales forum operator, who then performs the steps of the method 22 of FIG. 2. Of course, a single party may carry out both methods 20, 22, in which case certain steps may be combined, or skipped altogether.

Beginning then at block 60, the sales forum operator may select activity themes from the group selected by the manufacturer at block 40. The sales forum operator may select some or all of the activity themes selected by the manufacturer. For example, where the sales forum operator does not carry clothing or bedding, the sales forum operator may determine that the Getting Dressed and Bedtime activity themes are not necessary, and thus not select these activity themes for use in their sales forum.

At block 62, the sales forum operator may optionally select a concept. According to certain embodiments of the present disclosure, the manufacturer may provide the sales forum operator with only the activity themes, the lists of goods and the instructional materials, and may leave the selection of the concept to be used up to the sales forum operator. Alternatively, the manufacturer may provide a plurality of grouped activity themes, lists of goods, instructional materials and signage, each group representing a different concept, and the sales forum operator may then select a particular concept. As a further alternative, the sales forum operator may accept whatever concept has previously been selected by the manufacturer at block 42, for example.

The method 22 may then pass to block 64, where the sales forum operator establishes an activity theme area in its sales forum for each of the activity themes selected at block 60. The exact nature of the operator's performance of the block 64 will vary according to the sales forum associated with the operator. For example, where the operator runs a physical retail establishment (a so-called “bricks and mortar” establishment), the action of establishing an activity theme area may represent identifying a section of shelf space or shelving or an area of sales floor for the activity theme area. Where the operator runs a virtual establishment (a so-called “on-line” or “Internet” establishment), the action of establishing an activity theme area may represent creating and maintaining a webpage or a series or webpages, which webpages may be linked to each other.

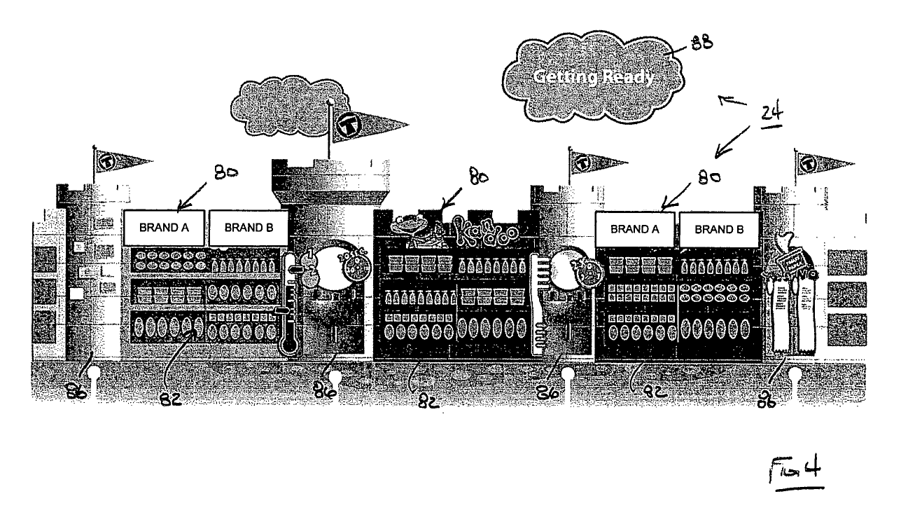

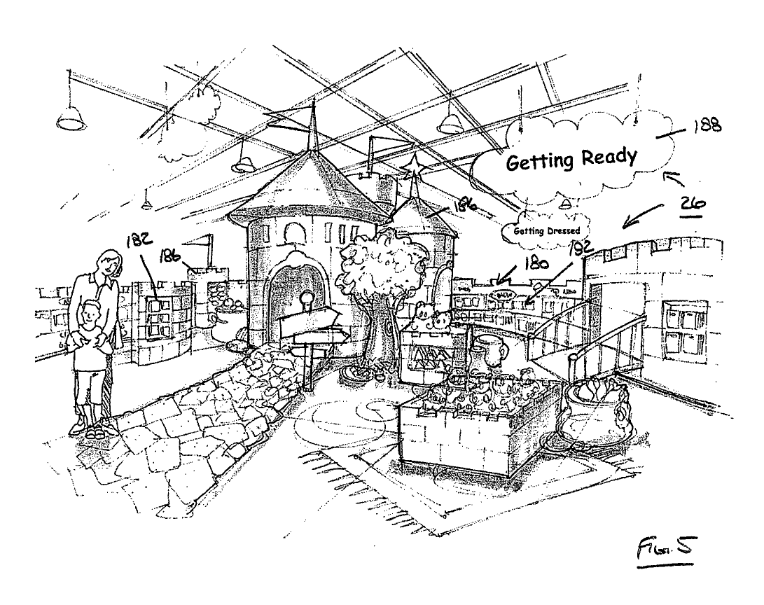

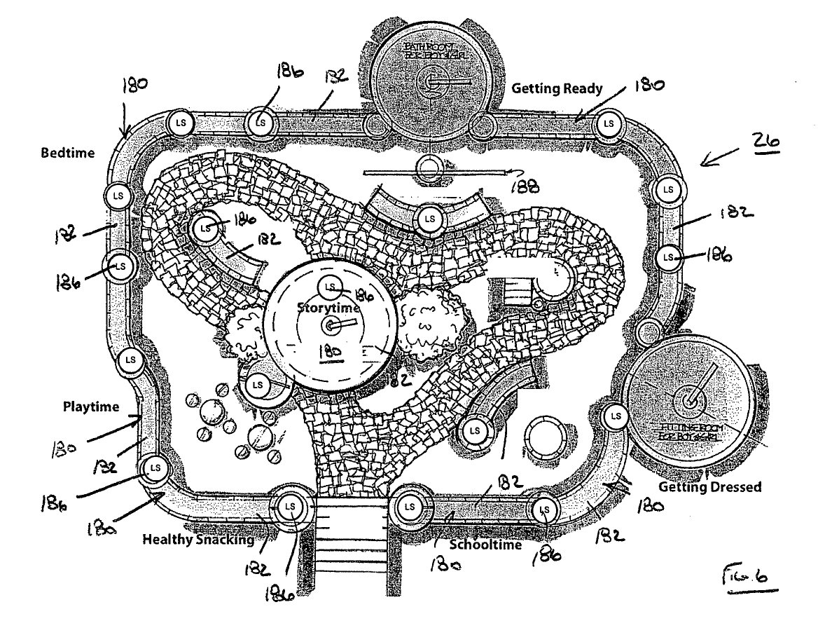

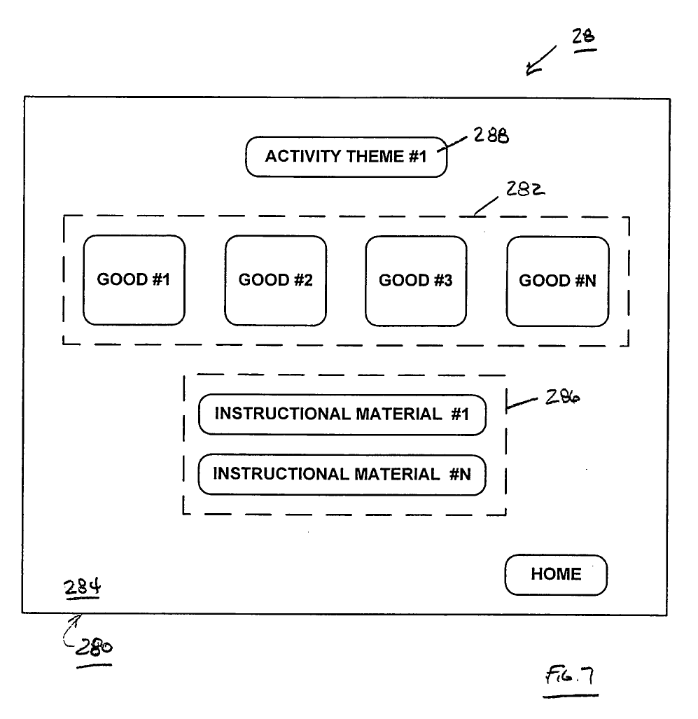

Examples of activity theme areas 80, 180, 280 are provided in FIGS. 3-7. As will be recognized from review of FIGS. 3 and 4, the activity theme areas 80 include linear shelving units, such as are commonly found in retail establishments. By contrast, the activity theme areas 180 illustrated in FIGS. 5 and 6 do not conform to the common linear shelving, but instead utilize shelving that is non-linear. In fact, the shelving associated with the activity theme areas 180 bounds a region having a width and a length, and in which may be disposed additional shelving or display units. In distinction to both the areas 80 and the areas 180, the area 280 shown in FIG. 7 is not a physical area, but a virtual area, such as may be established on one or more webpages, which webpages may be linked to each other.

At a block 66, the sales forum operator may display goods in each activity theme area 80, 180, 280. In the case of the areas 80, 180, the sales forum operator may display the goods associated with an activity theme area by having employees or other workers dispose the goods on shelving or display areas 82, 182. A customer, whether a caregiver or child, may select the goods from the shelving or display areas 82, 182. Alternatively, in the case of the areas 280, the sales forum operator may display the goods by including pictures, graphical representations and/or textual descriptions of the goods, represented schematically at 282, on a web page 284. A customer, typically the caregiver, may select the goods from the webpage 284 by clicking on the picture, representation and/or description, for example. The display areas 82, 182, 282 may include design elements selected according to a selected concept.

In the case of the shelving or display areas 82, 182 according to the embodiments shown in FIGS. 3-6, it may be desirable to limit the height of the topmost shelf or display. Children in the age group 3-7 years old are beginning to experience an expanded sense of independence, and a desire to be included in the decisions which affect their daily routine. This desire to be included can have a beneficial effect for the caregiver, to the extent that the child's desire to be included in these decisions may also be accompanied by a greater personal investment in the decision once made. However, to be included in the decision-making process, it is believed important that the child be permitted to see the goods to be selected. Consequently, if shelving or display areas are taller than the average 3-7 year old, then the goods displayed on these shelving or display areas are not visible to the child, and the child's ability to participate in the goods selection process is limited. Thus, according to certain embodiments of the present disclosure, the height of the topmost shelf or display unit may be limited to about 4 feet (1.22 meters).

At block 68, the sales forum operator may provide instructional materials to the caregiver and/or child. As explained above, these instructional materials may be provided by a third party, such as a manufacturer of the goods displayed, at least in part, in the display areas 82, 182, 282. Alternatively, the sales forum operator may create the materials, as well as providing them to the customer. As also explained above, the instructional materials may be interactive, at least in part, although this need not be the case according to all embodiments.

The sales forum operator may provide the instructional materials associated with a particular activity theme within the activity theme area 80, 180, 280 which the sales forum operator has established for this purpose. In particular, each activity theme area 80, 180, 280 may include a learning station 86, 186, 286 at which the instructional materials are provided. The learning stations 86, 186, 286 are in close proximity to the display areas 82, 182, 282 for the respective activity themes. According to the linear shelving embodiment shown in FIGS. 3 and 4, the learning stations 86 may be disposed adjacent to the display areas 82 in each activity theme area 80, and in particular abutting at least one edge of the display areas 82. According to the non-linear embodiment shown in FIGS. 5 and 6, the learning stations 186 may be disposed at either end of the shelving or display areas assigned to the activity theme area. According to the virtual embodiment of FIG. 7, the learning station 286 may include a portion of the webpage that has been established to contain pictures, graphical information and/or textual information or links to such information. Like the display areas 82, 182, 282, the learning stations 86, 186, 286 may include design elements selected according to a selected concept.

At block 70, the sales forum operator may display signage 88, 188, 288 that indicates the presence of the various activity theme areas 80, 180, 280 established by the sales forum operator. As indicated above, this signage may be designed and provided to the sales forum operator by a third party, such as a manufacturer. Alternatively, the sales forum operator may be responsible for providing its own signage. As also indicated above, the signage may include letters and/or pre-literate symbols helpful in assisting the caregiver and/or child to identify the various activity theme areas 80, 180, 280. The signage may be physical (as illustrated in FIGS. 3-6) or virtual (as illustrated in FIG. 7), in which case the signage may include banners, text boxes, graphics boxes and the like. 5 The methods 20, 22 and systems 24, 26, 28 may provide advantages for the party performing the method 20 (e.g., a manufacturer of children's goods), the party performing the method 22 (e.g., an operator of a retail or on-line establishment) and the customer (e.g., the caregiver and child). Preferably, the methods 20, 22, and systems 24, 26, 28 provide these advantages to each of the parties at the same time, creating mutually beneficial situations for the manufacturer, retailer, and customer (so-called “win-win” situations).

For instance, the daily routine of the caregiver and child already is focused around, at least in part, the activities of the child because of the yet incomplete independence of the child. In this regard, the organization of the goods around activity themes selected according to the daily routine of the child carries over the organization used by caregiver and child throughout the remainder of the day into the sales or shopping experience. It is believed that by carrying over the organizational system into the shopping experience, both the caregiver and the child will find it more intuitive to select the “right” items needed for the day, thereby limiting the negative impact a shopping trip can otherwise have on the daily routine.

Additionally, according to the methods and systems of the present disclosure, the interaction between the caregiver and the child may be facilitated. The learning stations, particular focused on the activity theme to which they are associated, assist the caregiver in instructing the child in proper safety, manners, and hygiene, according to some embodiments through caregiver-child interaction. The instruction may assist the child on his or her way to becoming more independent and self-sufficient, a status or level important to many children, in particular those in the 3-7 year old age group. The interaction may provide an opportunity for the caregiver and the child to turn what would have been another trip to the store into a sharing experience between caregiver and child. The sharing experience may enhance the caregiver's and/or the child's feelings that the trip to the store was a “good” trip. Alternatively, a non-shared experience may still have the benefit of assisting in occupying the child while permitting the caregiver to select goods from the shelving or display areas 82, 182, 282.

Assisting in these behaviors may also have a benefit to the retailer and the manufacturer. For example, it is believed that caregivers will recognize and appreciate the opportunities to find teachable moments with the children in their care, and will spend more time in the retail establishments and in the areas of the retail establishments that provide theme with these teachable moments, as opposed to, for example, a store that has the traditional row upon row of linear shelving. Moreover, it is believed that the children will recognize and anticipate the opportunities to learn so as to become more independent, and to interact with the caregiver so as to renew the emotional bond between caregiver and child. It is further believed that this appreciation and anticipation will create a customer preference of both caregiver and child for a retail establishment that provide the system 24, 26, 28, leading to more sales from these stores in the first instance, and satisfaction (from the caregiver) and enthusiasm (from the child) about the purchases, leading to repeat sales in the second instance.

It is also believed that the association of goods is an important aspect of the marketing and sales process. Studies suggest that placement of a good in a retail establishment may be of high importance to its purchase by the customer. By grouping goods in a fashion more intuitive to the customer, it is believed that sales may be enhanced.

All documents cited in the Detailed Description are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A merchandising method comprising:
selecting a plurality of activity themes, each activity theme corresponding to an activity performed by a child during a day;
separating goods according to the plurality of activity themes, the goods for one of the plurality of activity themes to be displayed in a display area for the one of the plurality of activity themes; and
providing instructional materials according to the plurality of activity themes to assist a caregiver in instructing a child regarding the respective activity theme, the instructional materials for one of the plurality of activity themes to be disposed at a learning station in close proximity to the display area for the one of the plurality of activity themes.

2. The merchandising method according to claim 1, the activity theme being selected from the group consisting of “Getting Dressed”, “Schooltime”, “Healthy Snacking”, “Playtime”, “Storytime”, “Bedtime”, and “Getting Ready”.

3. The merchandising method according to claim 1, comprising designing signage that represents each activity theme in letters, pre-literate symbols or a combination thereof.

4. The merchandising method according to claim 1, comprising creating interactive instructional materials for use by one of a caregiver and a child to assist the caregiver in instructing the child regarding the respective activity theme.

5. The merchandising method according to claim 1, comprising selecting a concept, the display area and the learning station including design elements selected according to the concept.

6. The merchandising method according to claim 5, wherein the concept consists of a concept from the group of concepts including Castle, Backyard, Hollywood, Circus, Safari, Pirate, and Marketplace.

7. A merchandising method comprising:
establishing an activity theme area in a sales forum for each of a plurality of activity themes,
each activity theme corresponding to an activity performed by a child during a day, and each activity theme area including a display area and a learning station in close proximity to the display area;
displaying goods corresponding to each activity theme in the respective display area; and
providing instructional materials related to each activity theme in the respective learning station to assist a caregiver in instructing a child regarding the respective activity theme.

8. The merchandising method according to claim 7, comprising selecting the plurality of activity themes from a group of activity themes.

9. The merchandising method according to claim 8, the plurality of activity themes being selected from the group consisting of “Getting Dressed”, “Schooltime”, “Healthy Snacking”, “Playtime”, “Storytime”, “Bedtime”, and “Getting Ready”.

10. The merchandising method according to claim 7, comprising selecting a concept, the display area and the learning station including design elements selected according to the concept.

11. The merchandising method according to claim 7, displaying signage that represents each activity theme in letters, pre-literate symbols or a combination thereof.

12. The merchandising method according to claim 7, providing interactive instructional materials for use by one of a caregiver and a child to assist the caregiver in instructing the child regarding the respective activity theme.

13. A merchandising system comprising:
a plurality of activity theme areas in a sales forum for each of a plurality of activity themes,
each activity theme corresponding to an activity performed by a child during a day, and each activity theme area including a display area and a learning station in close proximity to the display area;
the display area including a display for goods corresponding to the activity theme, and
the learning station including instructional materials related to the activity theme to assist a caregiver in instructing a child regarding the respective activity theme.

14. The merchandising system according to claim 13, the activity theme being selected from the group consisting of “Getting Dressed”, “Schooltime”, “Healthy Snacking”, “Playtime”, “Storytime”, “Bedtime”, and “Getting Ready”.

15. The merchandising system according to claim 13, the sales forum comprising a physical location and the activity theme area comprising linear shelving units.

16. The merchandising system according to claim 13, the sales forum comprising a physical location and the activity theme area comprising non-linear shelving units.

17. The merchandising system according to claim 13, the sales forum comprising a virtual location and the activity theme area comprising a web page.

18. The merchandising system according to claim 13, the display has goods disposed thereon at a height of less than four feet (1.22 meters).

19. The merchandising system according to claim 13, wherein the instructional materials include information regarding safety, hygiene, manners or any combination thereof.
